(19) United States
(12) Patent Application Publication
(10) Pub. No.: US 2010/0231990 A1
(43) Pub. Date: Sep. 16, 2010

(54) SCAN APPARATUS AND IMAGE FORMING APPARATUS

(75) Inventors: Jun Sakakibara, Tokyo-to (JP); Koji Tanimoto, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/719,947

(22) Filed: Mar. 9, 2010

Related U.S. Application Data
(60) Provisional application No. 61/158,820, filed on Mar. 10, 2009.

(51) Int. Cl. H04N 1/04

(52) U.S. Cl. 358/475

(57) ABSTRACT

There is provided a scan apparatus in which a thickness of a red filter layer is a value except the integral multiple of a wavelength at which sensitivity of red photodiodes becomes maximum in a wavelength region of red light, a thickness of a green filter layer is a value except the integral multiple of a wavelength at which sensitivity of green photodiodes becomes maximum in a wavelength region of green light, and a thickness of a blue filter layer is a value except the integral multiple of a wavelength at which sensitivity of blue photodiodes becomes maximum in a wavelength region of blue light.

### CROSS-REFERENCE TO RELATED APPLICATION

This application is based upon and claims the benefit of priority from: U.S. Provisional Application No. 61/158,820 filed on Mar. 10, 2009, the entire contents of which are incorporated herein by reference.

### TECHNICAL FIELD

The present invention relates to a scan apparatus to read an image and an image forming apparatus.

### BACKGROUND

An image forming apparatus, for example, a color copier includes a scan apparatus to optically read a color image of a document. As disclosed in, for example, JP-A-2006-196532 and JP-A-11-297975, the scan apparatus includes a CCD sensor to receive reflected light from a document and to perform photoelectric conversion. The CCD sensor includes a red line sensor array, a green line sensor array and a blue line sensor array.

The red line sensor array includes a red filter layer passes red light, and plural red photodiodes to receive the light passing through the red filter layer. The green line sensor array includes a green filter layer passes green light and plural green photodiodes to receive the light passing through the green filter layer. The blue line sensor array includes a blue filter layer passes blue light and plural blue photodiodes to receive the light passing through the blue filter layer.

The red filter layer has a front surface on which light is incident and a back surface from which light exits. A part of the red light incident on the front surface of the red filter layer is reflected by the back surface of the red filter layer and can return to the front surface side. Thus, the reflected light interferes with the incident red light, and the energy of the red light exiting from the red filter layer can attenuate. In this case, it becomes difficult to accurately and stably scan a red image.

Similarly, the energies of green light and blue light exiting from the green filter layer and the blue filter layer can attenuate. In this case, it becomes difficult to accurately and stably scan a green image and a blue image.

### SUMMARY

According to an aspect of the present invention, a scan apparatus includes a CCD sensor to receive reflected light from a document, in which the CCD sensor includes a red line sensor array having a red filter layer configured to pass red light and plural red photodiodes to receive light passing through the red filter layer, a green line sensor array having a green filter layer configured to pass green light and plural green photodiodes to receive light passing through the green filter layer, and a blue line sensor array having a blue filter layer configured to pass blue light and plural blue photodiodes to receive light passing through the blue filter layer,
a thickness of the red filter layer is a value except the integral multiple of a wavelength at which sensitivity of the red photodiodes becomes maximum in a wavelength region of the red light,
a thickness of the green filter layer is a value except the integral multiple of a wavelength at which sensitivity of the green photodiodes becomes maximum in a wavelength region of the green light, and
a thickness of the blue filter layer is a value except the integral multiple of a wavelength at which sensitivity of the blue photodiodes becomes maximum in a wavelength region of the blue light.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiment of the invention, and together with the general description given above and the detailed description of the embodiment given below, serve to explain the principles of the invention.

FIG. 1 is a view showing a structure of a scan apparatus of an embodiment and an image forming apparatus including the scan apparatus.

FIG. 2 is a view showing a document, a document plate and an exposure lamp according to the embodiment.

FIG. 3 is a view showing a structure of a CCD sensor of the embodiment.

FIG. 4 is a view of a section along line A-A of FIG. 4 when viewed in an arrow direction.

FIG. 5 is a view showing spectral sensitivity characteristics of the CCD sensor of the embodiment.

FIG. 6 is a view showing, for reference, an example in which when a thickness Dr of a red filter layer is not appropriate, reflected light is generated in the red filter layer.

FIG. 7 is a view showing an example of light incident on a red filter layer of the embodiment, light passing through the red filter layer, light exiting from the red filter layer, and a thickness Dr of the red filter layer.

FIG. 8 is a view showing an example of light incident on a green filter layer of the embodiment, light passing through the green filter layer, light exiting from the green filter layer, and a thickness Dg of the green filter layer.

FIG. 9 is a view showing an example of light incident on a blue filter layer of the embodiment, light passing through the blue filter layer, light exiting from the blue filter layer, and a thickness Db of the blue filter layer.

### DETAILED DESCRIPTION

Hereinafter, an embodiment of the present invention will be described with reference to the drawings.

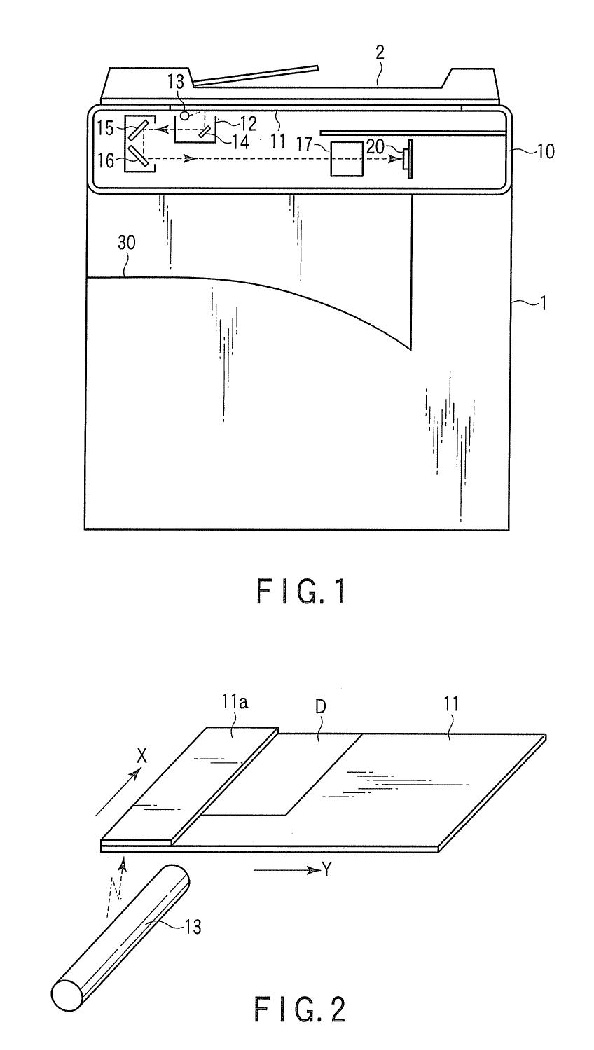

As shown in FIG. 1, an auto document feeder (ADF) 2 is openably and closably provided at an upper part of a main body 1, and a scan apparatus 10 is provided below the auto document feeder 2. As shown in FIG. 2, the scan apparatus 10 includes a transparent document plate 11 on which a document D is set. The auto document feeder 2 automatically feeds one or plural documents to the document plate 11 one by one. The document plate 11 includes an indicator 11a. An edge of the indicator 11a is a reference position for document setting.

A carriage 12 is provided at a lower surface side of the document plate 11, and an exposure lamp 13 is provided in the carriage 12. The carriage 12 reciprocates along the lower surface of the document plate 11. The exposure lamp 13 is turned on while the carriage 12 reciprocates, so that the document D on the document plate 11 is exposed to light. Reflected light is generated from the document D by this exposure. The reflected light is guided to a CCD (Charge Coupled Device) sensor 20 by reflection mirrors 14, 15 and 16 and a variable-power lens block 17.

The CCD sensor 20 performs line scan of received light along an axial direction of the exposure lamp 13, and repeats the line scan in accordance with the reciprocation of the carriage 12. The direction of the line scan of the CCD sensor 20 is a main scan direction X. The reciprocate direction of the carriage 12 is a sub-scan direction Y.

A color printer 30 is provided below the scan apparatus 10 in the main body 1. The color printer 30 prints a color image corresponding to the output of the CCD sensor 20. A specific structure of the color printer 30 is disclosed in the previously filed Japanese Patent Application No. 11/688,516. Thus, the description of the structure is omitted.

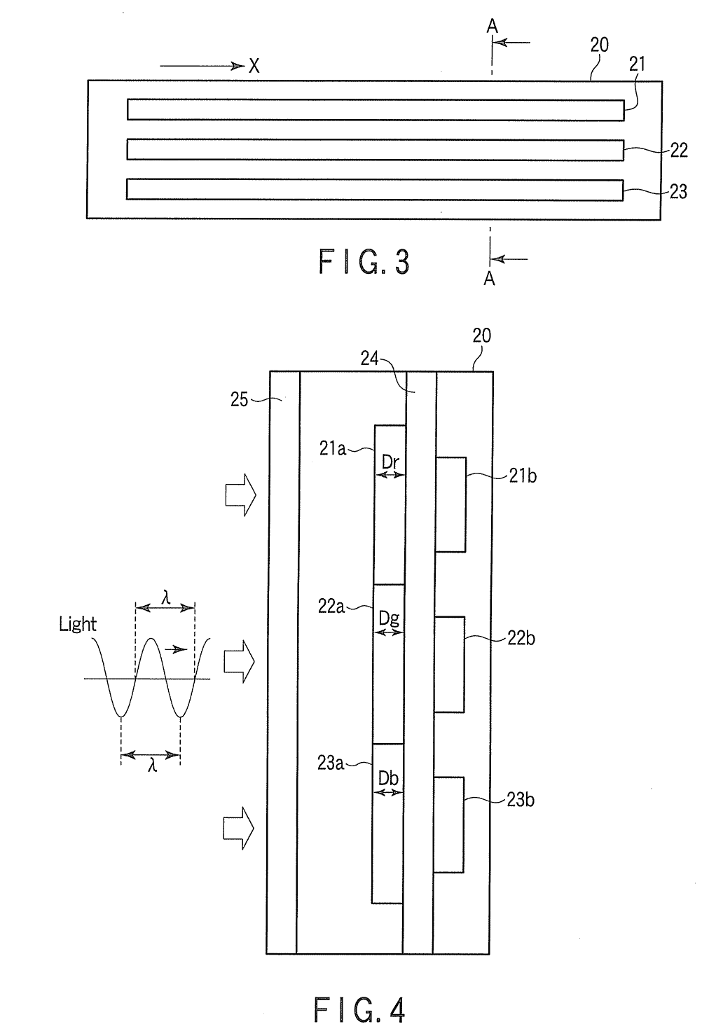

As shown in FIG. 3, the CCD sensor 20 includes a red line sensor array 21, a green line sensor array 22 and a blue line sensor array 23, each of which extends in the main scan direction X and has a line shape. FIG. 4 shows a section of the CCD sensor 20 along line A-A.

The red line sensor array 21 includes a red filter layer 21a passes red light of a wavelength in a visible light region and includes plural red photodiodes 21b to receive the light passing through the red filter layer 21a. The red photodiodes 21b are arranged along the main scan direction X in a line, receive the light passing through the red filter layer 21a and a base layer 24, and perform photoelectric conversion.

The green line sensor array 22 includes a green filter layer 22a passes green light of a wavelength in the visible light region and includes plural green photodiodes 22b to receive the light passing through the green filter layer 22a. The green photodiodes 22b are arranged along the main scan direction X in a line, receive the light passing through the green filter layer 22a and the base layer 24, and perform photoelectric conversion.

The blue line sensor array 23 includes a blue filter layer 23a passes blue light of a wavelength in the visible light region and includes plural blue photodiodes 23b to receive the light passing through the blue filter layer 23a. The blue photodiodes 23b are arranged along the main scan direction X in a line, receive the light passing through the blue filter layer 23a and the base layer 24, and perform photoelectric conversion.

The transparent base layer 24 is provided on the respective light receiving surfaces of the red photodiodes 21b, the green photodiodes 22b and the blue photodiodes 23b. The red filter layer 21a, the green filter layer 22a and the blue filter layer 23a are provided on the base layer 24. A transparent cover glass 25 covers the base layer 24, the red filter layer 21a, the green filter layer 22a, and the blue filter layer 23a.

Especially, a thickness Dr of the red filter layer 21a is determined in view of the spectral sensitivity characteristic of the respective red photodiodes 21b. Similarly, a thickness Dg of the green filter layer 22a is determined in view of the spectral sensitivity characteristic of the respective green photodiodes 22b. Similarly, a thickness Db of the blue filter layer 23a is determined in view of the spectral sensitivity characteristic of the respective blue photodiodes 23b.

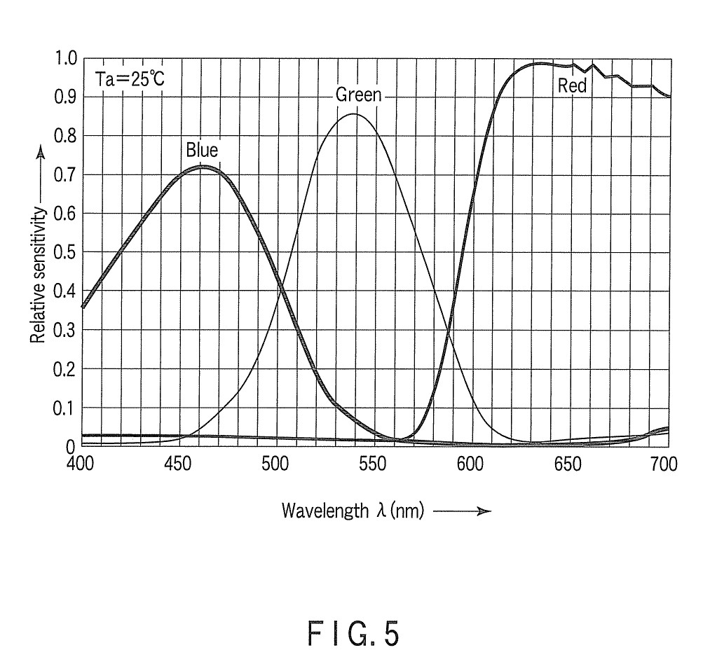

FIG. 5 shows the spectral sensitivity characteristics of the respective red photodiodes 21b, the respective green photodiodes 22b and the respective blue photodiodes 23b. Incidentally, wavelengths of the visible light region are 400 to 700 (nm).

The respective red photodiodes 21b have sensitivity to a wavelength λr in a specified range of 550 to 700 (nm) among the wavelengths of the visible light region. Besides, in the wavelength λr, a wavelength λrp at which the sensitivity of the red photodiodes 21b becomes maximum is 630 (nm).

The respective green photodiodes 22b have sensitivity to a wavelength λg in a specified range of 400 to 700 (nm) among the wavelengths of the visible light region. Besides, in the wavelength λg, a wavelength λgp at which the sensitivity of the green photodiodes 22b becomes maximum is 540 (nm).

The respective blue photodiodes 23b have sensitivity to a wavelength λb in a specified range of 400 to 550 (nm) among the wavelengths of the visible light region. Besides, in the wavelength λb, a wavelength λbp at which the sensitivity of the blue photodiodes 23b becomes maximum is 460 (nm).

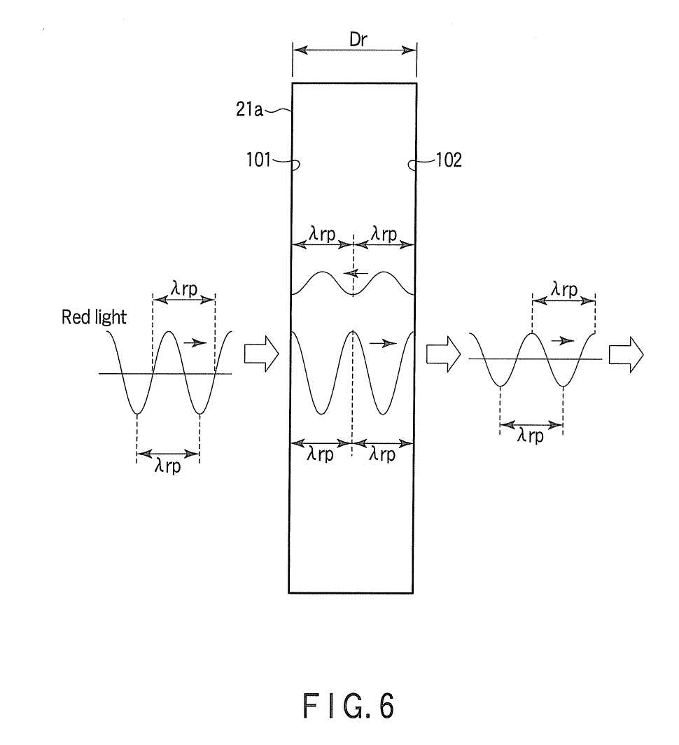

On the other hand, as shown in FIG. 6, the red filter layer 21a has a front surface 101 on which light is incident, and a back surface 102 from which light exits. When the thickness Dr of the red filter layer 21a is a value except the integral multiple of the wavelength λrp, the phase of the red light of the wavelength λrp reflected by the back surface 102 and returned to the front surface 101 synchronizes with the phase of the red light of the wavelength λrp incident on the front surface 101. In this case, the reflected and returned red light of the wavelength λrp interferes with the incident red light of the wavelength λrp. By this interference, the energy of the red light of the wavelength λrp, which exits from the front surface 101, is attenuated, and it becomes impossible to operate the red photodiodes 21b at the maximum sensitivity. As a result, it becomes difficult to accurately and stably scan a red image.

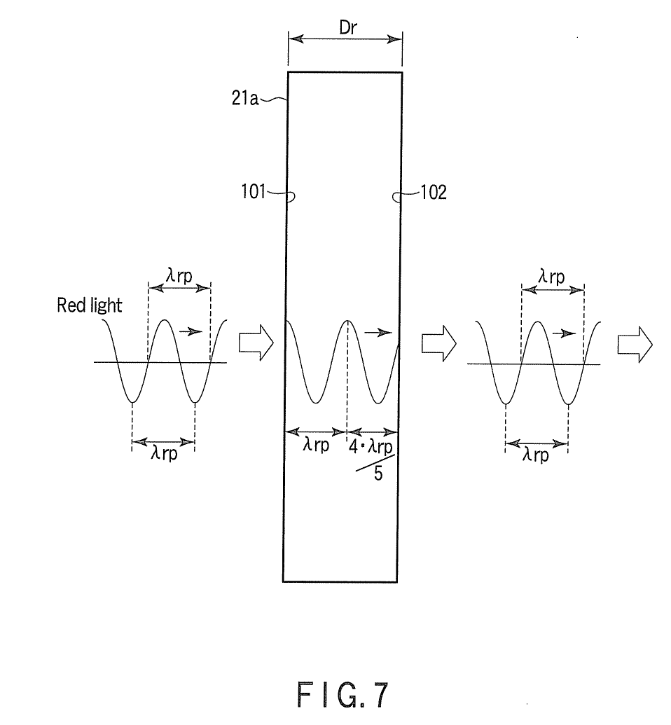

Then, as shown in FIG. 7, the thickness Dr of the red filter layer 21a is set to a value except the integral multiple of the wavelength λrp at which the sensitivity of the red photodiodes 21b becomes maximum, for example, “λrp+(4·λrp/5)”.

By this setting, the phase of the red light of the wavelength λrp reflected by the back surface 102 of the red filter layer 21a and returned to the front surface 101 side does not synchronize with the phase of the red light of the wavelength λrp incident on the front surface 101. Accordingly, the red light of the wavelength λrp passes through the red filter layer 21a without energy attenuation. Accordingly, the respective red photodiodes 21b can be operated at the maximum sensitivity. As a result, it becomes possible to accurately and stably scan a red image.

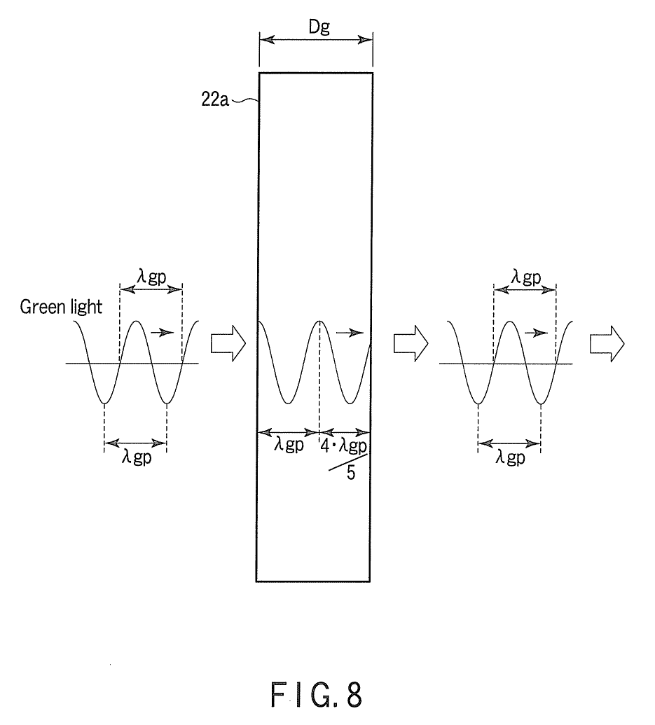

Similarly, as shown in FIG. 8, the thickness Dg of the green filter layer 22a is set to a value except the integral multiple of the wavelength λgp at which the sensitivity of the green photodiodes 22b becomes maximum, for example, “λgp+(4·λgp/5)”. By this setting, the green light of the wavelength λgp passes through the green filter layer 22a without energy attenuation. Accordingly, the respective green photodiodes 22b can be operated at the maximum sensitivity. As a result, it becomes possible to accurately and stably scan a green image.

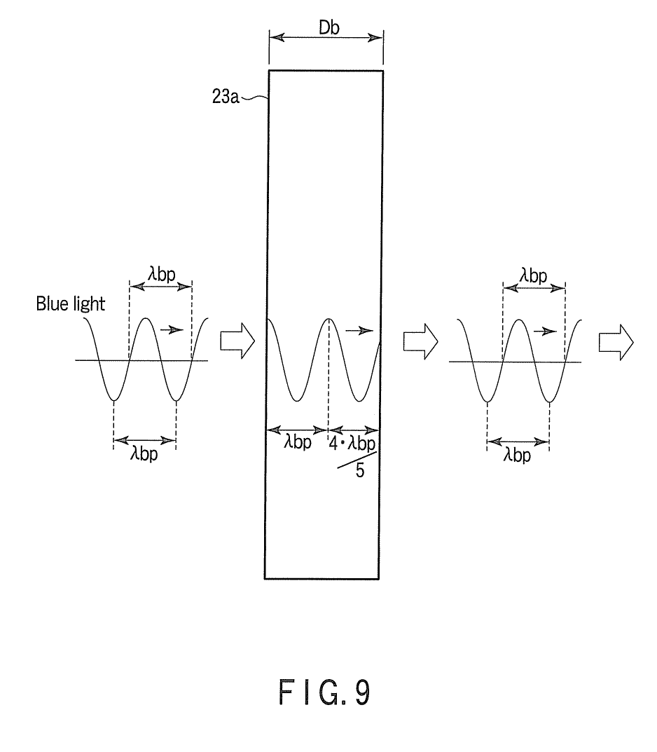

Similarly, as shown in FIG. 9, the thickness Db of the blue filter layer 23a is set to a value except the integral multiple of the wavelength λbp at which the sensitivity of the blue photodiodes 23b becomes maximum, for example, “λbp+(4·λbp/5)”. By this setting, the blue light of the wavelength λbp passes through the blue filter layer 23a without energy attenuation. Accordingly, the respective blue photodiodes 23b can be operated at the maximum sensitivity. As a result, it becomes possible to accurately and stably scan a blue image.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A scan apparatus comprising:
a CCD sensor to receive reflected light from a document, wherein the CCD sensor includes a red line sensor array having a red filter layer configured to pass red light and a plurality of red photodiodes to receive light passing through the red filter layer, a green line sensor array having a green filter layer configured to pass green light and a plurality of green photodiodes to receive light passing through the green filter layer, and a blue line sensor array having a blue filter layer configured to pass blue light and a plurality of blue photodiodes to receive light passing through the blue filter layer,
a thickness of the red filter layer is a value except the integral multiple of a wavelength at which sensitivity of the red photodiodes becomes maximum in a wavelength region of the red light,
a thickness of the green filter layer is a value except the integral multiple of a wavelength at which sensitivity of the green photodiodes becomes maximum in a wavelength region of the green light, and
a thickness of the blue filter layer is a value except the integral multiple of a wavelength at which sensitivity of the blue photodiodes becomes maximum in a wavelength region of the blue light.

2. The apparatus of claim 1, wherein
the red filter layer passes the red light of a wavelength in a visible light region,
the green filter layer passes the green light of a wavelength in the visible light region, and
the blue filter layer passes the blue light of a wavelength in the visible light region.

3. The apparatus of claim 1, wherein
the red photodiodes are arranged in a line, receive the light passing through the red filter layer and perform photoelectric conversion,
the green photodiodes are arranged in a line, receive the light passing through the green filter layer and perform photoelectric conversion, and
the blue photodiodes are arranged in a line, receive the light passing through the blue filter layer and perform photoelectric conversion.

4. The apparatus of claim 1, wherein
the red photodiodes have sensitivity to a wavelength λr in a specified range of red light wavelengths in a visible light region, and have maximum sensitivity to a wavelength λrp in the wavelength λr,
the green photodiodes have sensitivity to a wavelength λg in a specified range of green light wavelengths in the visible light region, and have maximum sensitivity to a wavelength λgp in the wavelength λg, and
the blue photodiodes have sensitivity to a wavelength λb in a specified range of blue light wavelengths in the visible light region, and have maximum sensitivity to a wavelength λbp in the wavelength λb.

5. The apparatus of claim 1, wherein
the CCD sensor includes a transparent base layer provided on the red photodiodes, the green photodiodes and the blue photodiodes, and the red filter layer, the green filter layer and the blue filter layer are provided on the base layer.

6. The apparatus of claim 5, wherein
the CCD sensor includes a transparent cover glass to cover the base layer, the red filter layer, the green filter layer and the blue filter layer.

7. The apparatus of claim 1, further comprising:
a transparent document plate on which the document is set; and
an exposure lamp configured to expose the document on the document plate.

8. The apparatus of claim 7, wherein
the CCD sensor receives the reflected light from the document by the exposure.

9. An image forming apparatus comprising:
a transparent document plate on which a document is set;
an exposure lamp configured to expose the document on the document plate;
a CCD sensor which receives reflected light from the document generated by exposing and includes a red line sensor array having a red filter layer configured to pass red light and a plurality of red photodiodes to receive light passing through the red filter layer, a green line sensor array having a green filter layer configured to pass green light and a plurality of green photodiodes to receive light passing through the green filter layer, and a blue line sensor array having a blue filter layer configured to pass blue light and a plurality of blue photodiodes to receive light passing through the blue filter layer; and
a color printer configured to print a color image corresponding to an output of the CCD sensor; wherein
a thickness of the red filter layer is a value except the integral multiple of a wavelength at which sensitivity of the red photodiodes becomes maximum in a wavelength region of the red light,
a thickness of the green filter layer is a value except the integral multiple of a wavelength at which sensitivity of the green photodiodes becomes maximum in a wavelength region of the green light, and
a thickness of the blue filter layer is a value except the integral multiple of a wavelength at which sensitivity of the blue photodiodes becomes maximum in a wavelength region of the blue light.

10. The apparatus of claim 9, wherein
the red filter layer passes the red light of a wavelength in a visible light region,
the green filter layer passes the green light of a wavelength in the visible light region, and
the blue filter layer passes the blue light of a wavelength in the visible light region.

11. The apparatus of claim 9, wherein
the red photodiodes are arranged in a line, receive the light passing through the red filter layer and perform photoelectric conversion,
the green photodiodes are arranged in a line, receive the light passing through the green filter layer and perform photoelectric conversion, and
the blue photodiodes are arranged in a line, receive the light passing through the blue filter layer and perform photoelectric conversion.

12. The apparatus of claim 9, wherein
the red photodiodes have sensitivity to a wavelength λr in a specified range of red light wavelengths in a visible light region, and have maximum sensitivity to a wavelength λrp in the wavelength λr,
the green photodiodes have sensitivity to a wavelength λg in a specified range of green light wavelengths in the visible light region, and have maximum sensitivity to a wavelength λgp in the wavelength λg, and
the blue photodiodes have sensitivity to a wavelength λb in a specified range of blue light wavelengths in the visible light region, and have maximum sensitivity to a wavelength λbp in the wavelength λb.

13. The apparatus of claim 9, wherein
the CCD sensor includes a transparent base layer provided on the red photodiodes, the green photodiodes and the blue photodiodes, and the red filter layer, the green filter layer and the blue filter layer are provided on the base layer.

14. The apparatus of claim 13, wherein
the CCD sensor includes a transparent cover glass to cover the base layer, the red filter layer, the green filter layer and the blue filter layer.
